(19) United States
(12) Patent Application Publication
(10) Pub. No.: US 2012/0290985 A1
(43) Pub. Date: Nov. 15, 2012

(54) SYSTEM AND METHOD FOR PRESENTING AND INTERACTING WITH EPERIODICAL SUBSCRIPTIONS

(75) Inventor: Jaireh Tecarro, San Francisco, CA (US)

(73) Assignee: BARNES & NOBLE, INC., New York, NY (US)

(21) Appl. No.: 13/469,597

(22) Filed: May 11, 2012

Related U.S. Application Data
(60) Provisional application No. 61/484,898, filed on May 11, 2011.

(51) Int. Cl. G06F 3/048

(52) U.S. Cl. 715/841

(57) ABSTRACT

A system and method for organizing viewing and reading of electronic periodicals on electronic devices, particularly mobile devices. The user's periodicals are arranged on the device's User Interface (UI) in visual representations of stacks. Each stack represents a different one of the user's periodicals. As a user selects a particular stack representing a particular ePeriodical, the stack is animated to spread out in drawer or in a grid to display thumbnails representing the covers of individual issue of the ePeriodical. The user can scroll the drawer or grid to view the issues. If the user has ePeriodicals stored on remote servers, the user interface has a control that the user can activate to download the thumbnail covers of the remotely stored ePeriodicals. Once the user has found the desired ePeriodical to read, the cover thumbnail can be selected to open and display the ePeriodical.

### CROSS-REFERENCE TO RELATED APPLICATION

This application claims benefit of U.S. Provisional Application No. 61/484,898, filed May 11, 2011, which is hereby incorporated by reference.

### FIELD OF THE INVENTION

The present invention generally relates to systems and methods for presenting and interacting with user interfaces, and more particularly to systems and methods for presenting and interacting with a user interface on a mobile electronic book reader to properly display ePeriodical subscriptions.

### BACKGROUND OF THE INVENTION

Digital publications, ePeriodicals have become increasingly popular and prevalent in today's marketplace thanks in part to publishers' and marketers' desire to save on printing and shipping costs over the comparable costs for printed publications. The advent of the Internet has further increased the popularity of the digital publication format because new Internet-based distribution channels meant that the circulation and reach of a digital publication could rival or surpass that of its paper counterpart. The term ePeriodicals is intended to include digital publications that are published on a periodical basis, such as digital versions of magazines, or digital versions of newspapers.

However, one of the difficulties concomitant with the explosion and popularity of ePeriodicals is how to manage the user interface that allows a user to view, find and select all of the various ePeriodicals available to the user.

### SUMMARY OF THE INVENTION

As the viewing and reading of periodicals (e.g., magazines and newspapers) on electronic devices, particularly mobile devices, has become more popular, the need for organizing and interacting with these electronic versions of periodicals has grown. The present invention provides a new paradigm for representing, displaying and presenting ePeriodical subscriptions as a “stack” and displaying, presenting and viewing individual issues via a “drawer.” In the preferred embodiment, the user's periodicals are arranged on the device's User Interface (UI) in visual representations of stacks. Each stack represents a different one of the user's periodicals. For example, one stack may represent the user's subscription to Car and Driver™ while another stack represents the user's issues of the Wall Street Journal™.

As a user selects a particular stack representing the ePeriodical she wishes to read, the stack is animated to spread out in a drawer or in a grid pattern to display thumbnails representing the covers of individual issue of the ePeriodical. The user can scroll the drawer or grid to view the issues. In the preferred embodiment, in order to conserve the limited memory on a mobile device, only a certain number of issues of a user's periodicals are stored locally. However, in this preferred embodiment, all of the user's ePeriodicals are stored, archived, on a remote server (the “cloud”). If the user has ePeriodicals stored in the cloud, the UI has a control, e.g. a ‘More’ button, that the user can activate to download the thumbnail covers of the cloud stored ePeriodicals.

Once the user has found the ePeriodical she wants to read, she selects the cover thumbnail to open the ePeriodical. If the ePeriodical is stored in the cloud, this activation of the thumbnail cover causes the ePeriodical to be downloaded from the cloud and opened on the device.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a preferred user interface of the present invention;

FIG. 2 is a flow chart describing a preferred process of the present invention;

FIG. 3 depicts a system according to the present invention; and

FIG. 4 illustrates an electronic device according to the present invention.

### DETAILED DESCRIPTION OF THE INVENTION

The user interface portion of the present invention provides virtual periodical stacks and drawers that organize the display of the periodical content within an electronic-reader user's library. This unique system and method provides easy access to any object in the user's virtual library, or “locker,” that is periodical in nature, including, but not limited to, for example, newspapers and magazines, and displays these electronic periodicals in their own stack in the electronic reader's user interface.

In its preferred implementation, this organizational capability is a subsystem of an electronic reader software application, such as a Library application, which serves as an interface for users to display the content available on or through their devices. Most such applications today present e-reader content in an order that does not take into account media object types, let alone the periodical nature of some of the content.

Conventional portable devices provide sequential lists or grids of all of the contents (books, magazine, newspapers, digital music files, digital video files) available for use on the portable digital devices, without regard to the specific natures of the files. For example, a digital music file could be positioned in the list with a newspaper file immediately before and after it. In other cases, weeks or months of periodical issues from various publishers could be listed in one long list, sorted by title or issue date. While these methods of presentation are sufficient for some media types, they are not intuitive or efficient ways to organize ePeriodicals. The present invention specifically addresses the organization and display of ePeriodicals.

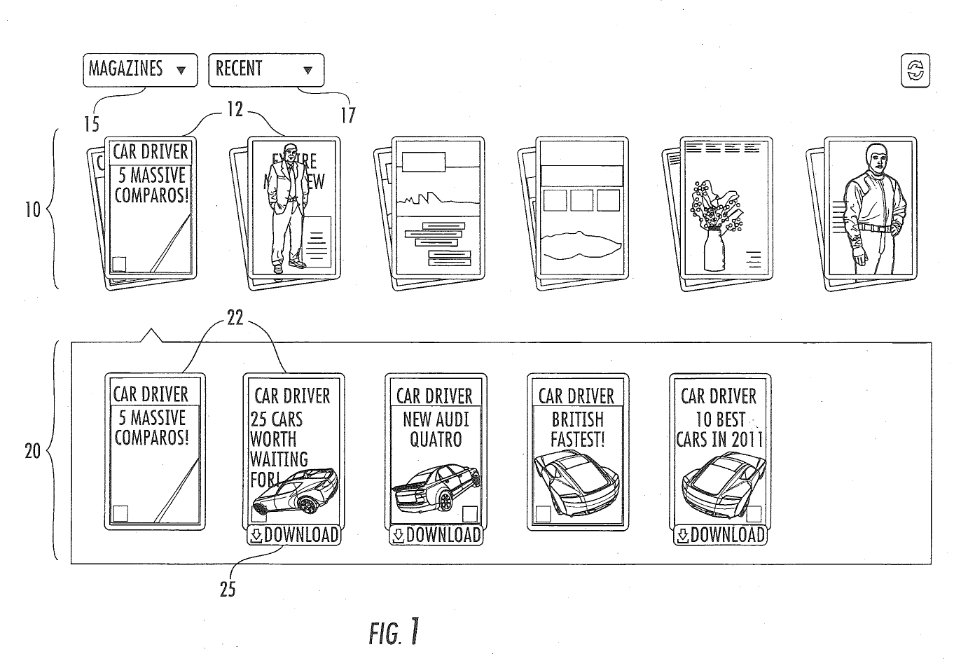

Referring to FIG. 1, in the preferred implementation, the present invention is implemented by a software subsystem comprised of various steps that, in total, survey the stored contents available to an electronic reader, and perform the operations necessary to support a representational display of those contents. In the preferred embodiment, the periodicals are presented in area 10 of the user interface illustrated in FIG. 1 in the form of stacks 12. In this preferred embodiment, there one periodical (subscription or title) per stack 12. As illustrated in this figure, the stacks 12 of periodicals visually appear as they would appear on a table or on someone's desk or shelf in an office, home or waiting room.

For example, there may be a Car and Driver™ magazine stack 12, an Esquire™ magazine stack 12, a New York Times™ newspaper stack 12, and so on, in area 10 of the user interface.

As appreciated by those skilled in the art, these stacks 12 of periodicals can be organized in a single row, in a grid pattern, or in any other esthetically pleasing configuration on user interface on the device's display. As further shown in FIG. 1, the top issue in any given stack 12 is preferably a thumbnail image of an issue of the periodical, preferably the latest issue available for viewing by the user on the device.

Using conventional navigation techniques, the user can scroll the rows and columns of stacks 12 both horizontally and vertically to view more stacks 12 of periodicals to which she has access.

Below stack area 10 is an area 20 in which the individual issues 22 of a particular periodical to which the user has access can be arrayed, with the individual instances of each preferably arrayed by date. As the user selects the stack 12 in area 10 corresponding to a particular periodical, the issues 22 of that periodical to which the user has access are arrayed in area 20. In a preferred embodiment, when the user selects a particular stack 12 (representing a particular periodical) the user interface animates the selected stack 12 in area 10 to appear to move to the drawer area 20. In this preferred embodiment, the user interface further animates the selected stack, 12 once moved to area 20, to spread out such that all of the individual issues 22 contained in the stack 12 are revealed and are selectable. In an alternative embodiment, the “drawer” fades after the user touches the stack 12 and reveals the individual issues 22.

In the embodiment illustrated in FIG. 1, the stacks 12 of area 10 and the issues 22 of area 20 are arranged in a single row in a horizontal manner. The user has the ability to scroll the user interface to the right and left in order to view all of the stacks 12 and all of the issues 22 within a stack 12. In alternative embodiments, several rows can be displayed, for example in a grid pattern, and a combination of horizontal and vertical presentation can be used.

In one preferred implementation, each issue's date will occur on or below the cover for that issue 22. In a preferred embodiment, the stacks 12 in area 10 and the issues 22 in area 20 are thumbnails images of the actual covers for the periodicals and actual issues 22 of those periodicals.

As further shown in FIG. 1, some of the icons representing individual issues 22 have a control button 25 labeled “DOWNLOAD” associated with the thumbnail image of the issue cover 22. As further described below, this “DOWNLOAD” control button 25 indicates that the copy of that particular issue 22 is not currently resident in the memory of the device. In the preferred of the present invention, the device used in connection with the present invention is mobile electronic device with a limited memory capacity. Accordingly, only a certain number of copies of ePeriodicals are stored on the device itself. In one embodiment this number is ten periodicals, but as appreciated by those skilled in the art, this number can be raised or lowered depending on the device's capacity and the desires of the user.

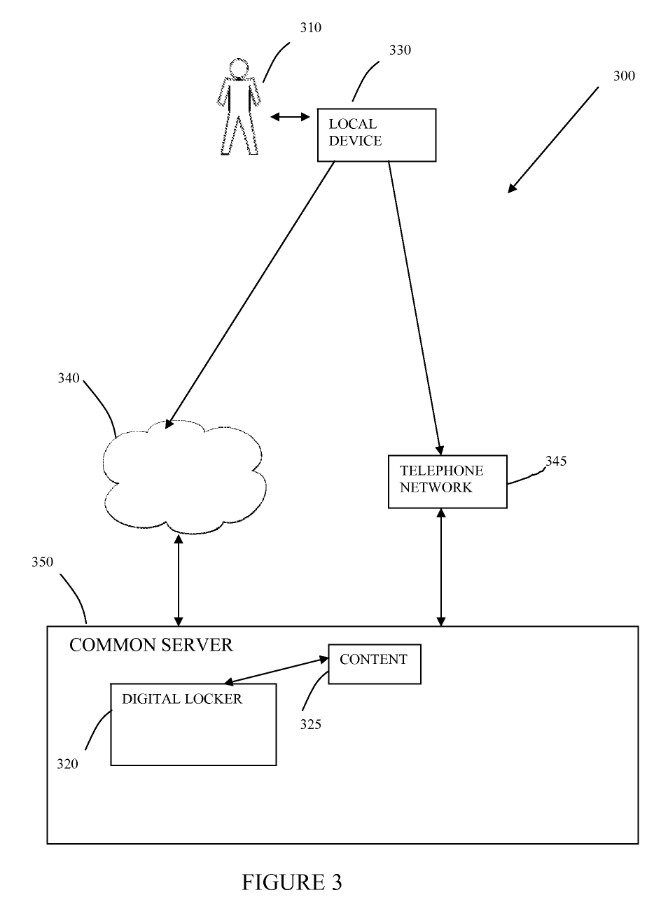

As further described below in connection with FIG. 3, the system of the present invention includes a remote server that provides “cloud” storage of all of the digital content to which the user can obtain access on her device. The remote server maintains a “digital locker” for each user that contains the actual copies of the content to which the user has rights, or a description of the content along with a link to the actual content.

If a particular issue 22 of an ePeriodical that the user wishes to read is not resident on the device, the user can simply select the “DOWNLOAD” control 25 to access the copy. In response to the detection of the activation of this “DOWNLOAD” control button 25, the device, using its communication capabilities, contacts the remote server to request the copy. After the remote server authenticates the request from the device, it accesses the user's locker to verify the user's rights to the copy and, if verified, downloads the copy to the device. Once downloaded onto the device, the user can open and read the selected ePeriodical.

A download control similar to the button 25 can be used in association with the stacks 12 if all of the various ePeriodicals to which the user has access are contained in the portion of the user's Library stored on the device.

Further illustrated in FIG. 1 are filter controls 15 and 17. Filter 15 can be used to filter the display by the type of periodical, for example, by magazine, newspaper or other periodical. Filter 17 can be used to sort or filter the ePeriodicals by date or other criteria.

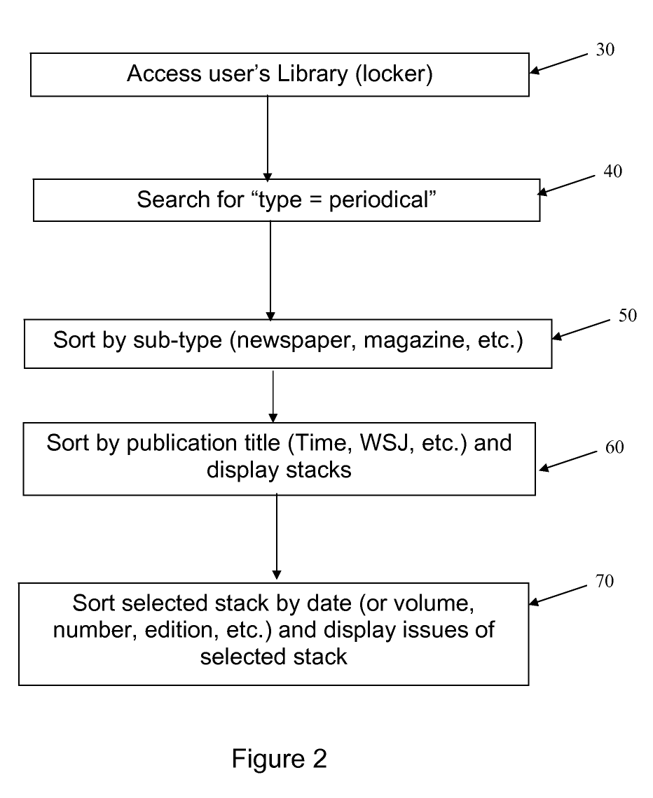

FIG. 2 describes a process according to a preferred embodiment of the present invention. This preferred embodiment operates on an electronic device, preferably a mobile device such as an eReader. The device includes at least a processor and a memory. The memory stores instructions that are executed by the processor to control the operation of the device.

In step 30, of the process, the digital content available for use (execution, viewing) is determined by accessing the device's library. In one embodiment of the present invention, the entirety of the user's Library is stored on the user's device. In another embodiment, only a part of the user's Library is stored on the device and the remainder of the Library is stored on a remote server as further described below. In the preferred embodiment, the library contains one or more records, identifiers, which describe each piece of content to which the user has rights. The library records contain the content's its various attributes and characteristics, such as a field that indicates that a particular piece of content is a periodical. The device's library can include identification of content that is stored local to the device and can also identify content that is remotely stored, but accessible by the device—e.g., through the Internet or other suitable communication medium.

In step 40, the method determines which of the contents in the user's library is of a periodical type (e.g., a newspaper or magazine). Again, in a preferred embodiment, the records for each of the content in the library contain an indication as to whether the content is periodical.

In step 50 the contents are then sorted by sub-type, where sub-types will include newspapers and magazines, but may also include other types of objects such as academic journals, newsletters, or other materials characterized by sharing a similar title and being published on a regular and recurring basis. Although this step is an optional step, it provides the user with an added level of filtering when searching for a particular ePeriodical. For example, the user might want to view only her magazines, so she can select the filter 15 as described above in connection with FIG. 1 and only display her magazine subscriptions, and not her newspapers.

In step 60 of the method, the sorted contents are further sorted by the title of the ePeriodical. This allows the system to create and display the separate stacks 12 of ePeriodicals in area 10 as described in FIG. 1. As previously described the icons representing the ePeriodicals are preferably depicted as stacks 12 of issues 22, with the top issue on the stack being a thumbnail image of one of the issues of the ePeriodical.

In step 70 of the process, the system detects that the user has selected the stack 12 of a particular ePeriodical for a more detailed viewing. In the preferred embodiment, the user I/O interface for making this selection is via a touchscreen on the device. To make the selection of the particular stack 12, the user simply taps on the icon (thumbnail image) that represents the ePeriodical. In response to this section by the user, the selected stack 12 is further sorted by date (though other sorts are possible) and the issues 22 of the title are individually displayed in area 20 as described above in connection with FIG. 1.

Alternative versions of the invention can be derived by altering the sequence of steps in FIG. 2. For example, it would be possible to have a stack 12 for each month of the year, and put all periodicals that arrive in a given month, say April, in the “April stack” irrespective of the titles of those periodicals. This alternative could also be applied to weeks or days, so that all newspapers arriving on a given day could be found in a single stack. If no issues arrived on a given day, that stack can be omitted.

FIG. 3 shows components of a system 300 according to the present invention. User 310 is an authorized user of system 300 and uses her local device 330 for the reading of digital content. In addition to the operation of local device 330, many of the functions of system 300 of the present invention are carried out on server 350. As appreciated by those skilled in the art, many of the functions described herein can be divided between the server 350 and the user's local device 330. Further, as also appreciated by those skilled in the art, server 350 can be considered a “cloud” with respect to the user and her local device 330. The cloud can actually be comprised of several servers performing interconnected and distributed functions. For the sake of simplicity in the present discussion, only a single server 350 will be described. The user 310 can connect to the server 350 via the Internet 340, a telephone network 345 (e.g., wirelessly through a cell phone network) or other suitable electronic communication means. User 310 has an account on lending server 350, which authorizes user 310 to use system 300.

Associated with the user's account is the user's digital locker 320 located on the server 350. As further described below, in the preferred embodiment of the present invention, digital locker 320 contains links to copies of digital content 325 previously purchased (or otherwise legally acquired) by user 310.

Indicia of rights to all copies of digital content 325 owned by user 310, is stored by reference in digital locker 320. Digital locker 320 is a remote online repository that is uniquely associated with the user's account. As appreciated by those skilled in the art, the actual copies of the digital content 325 are not necessarily stored in the user's locker 320, but rather the locker 320 stores an indication of the rights of the user to the particular content 325 and a link or other reference to the actual digital content 325. Typically, the actual copy of the digital content 325 is stored in another mass storage (not shown). The digital lockers 120 of all of the users who have purchased a copy of a particular digital content 325 would point to this copy in mass storage. Of course, back up copies of all digital content 325 are maintained for disaster recovery purposes. Although only one example of digital content 325 is illustrated in this Figure, it is appreciated that the lending server 350 can contain millions of files 325 containing digital content. It is also contemplated that the server 350 can actually be comprised of several servers with access to a plurality of storage devices containing digital content 325. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

User 310 can access his or her digital locker 320 using a local device 330. Local device 330 is an electronic device such as a personal computer, an e-book reader, a smart phone or other electronic device that the user 310 can use to access the server 350. In a preferred embodiment, the local device 330 has been previously associated, registered, with the user's 310 account using user's account credentials. Local device 330 provides the capability for user 310 to download a user's copy of digital content 325 via his or her digital locker 320. After digital content 325 is downloaded to local device 330, user 310 can engage with the downloaded content locally, e.g., read the book, listen to the music or watch the video.

As described above, in the preferred embodiment of a mobile device, the user's local device 330 has limited memory capacity, and therefore only a limited number of the ePeriodicals can be stored on the device 330. All of the user's ePeriodicals are stored on the remote server 350, at least by reference in the user's digital locker 320. If a particular ePeriodical is not stored on the user's local device 330, the ePeriodical can be requested and downloaded from the server 350 though the user's digital locker 320.

In a preferred embodiment, local device 330 includes a non-browser based device interface that allows user 310 access the server 350 in a non-browser environment. Through the device interface, the user 310 is automatically connected to the server 350 in a non-browser based environment. This connection to the server 350 is a secure interface and can be through the telephone network 345, typically a cellular network for mobile devices. If user 310 is accessing his or her digital locker 320 using the Internet 340, local device 330 also includes a web account interface. Web account interface provides user 310 with browser-based access to his or her account and digital locker 320 over the Internet 340.

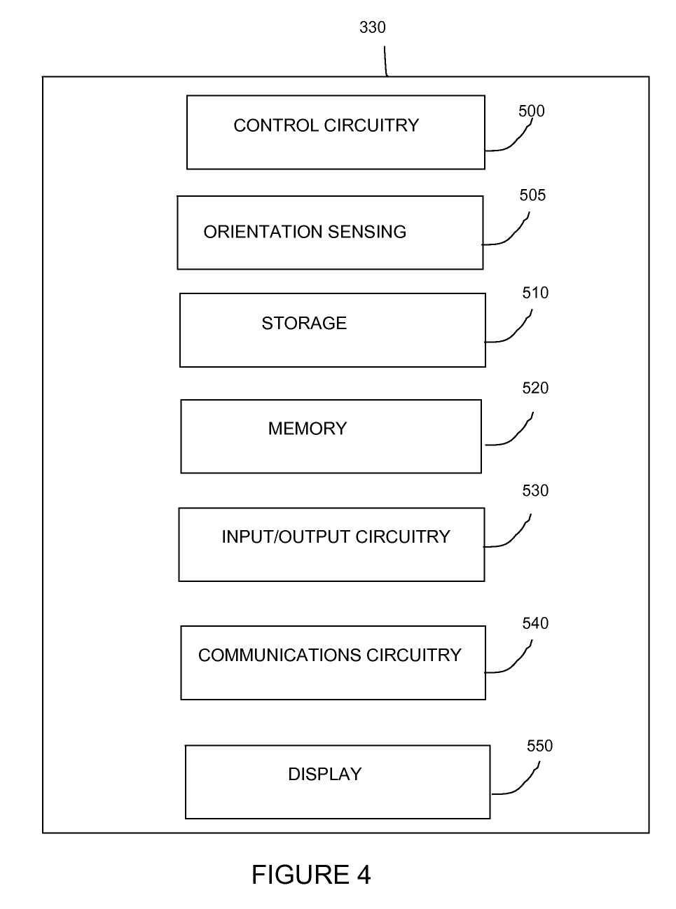

FIG. 4 illustrates an exemplary local device 330. As appreciated by those skilled the art, the local device 330 can take many forms capable of operating the present invention. As previously described, in a preferred embodiment the local device 330 is a mobile electronic device, and in an even more preferred embodiment device 330 is an electronic reader device. Electronic device 330 can include control circuitry 500, storage 510, memory 520, input/output (“I/O”) circuitry 530, communications circuitry 540, and display 550. In some embodiments, one or more of the components of electronic device 330 can be combined or omitted, e.g., storage 510 and memory 520 may be combined. As appreciated by those skilled in the art, electronic device 330 can include other components not combined or included in those shown in FIG. 4, e.g., a power supply such as a battery, an input mechanism, etc.

Electronic device 330 can include any suitable type of electronic device. For example, electronic device 330 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 330 can include a larger portable electronic device, such as a laptop computer. As yet another example, electronic device 330 can include a substantially fixed electronic device, such as a desktop computer.

Control circuitry 500 can include any processing circuitry or processor operative to control the operations and performance of electronic device 330. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 includes orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 330 as a whole. The orientation data is then fed to the control circuitry 500 which control an orientation sensing application. The orientation sensing application controls the graphical user interface (GUI), which drives the display 550 to present the GUI for the desired mode.

Storage 510 can include, for example, one or more storage mediums including a hard-drive, solid state drive, flash memory, permanent memory such as ROM, any other suitable type of storage component, or any combination thereof. Storage 510 can store, for example, media content, e.g., ePeriodicals, eBooks, music and video files, application data, e.g., software for implementing functions on electronic device 330, firmware, user preference information data, e.g., content preferences, authentication information, e.g. libraries of data associated with authorized users, transaction information data, e.g., information such as credit card information, wireless connection information data, e.g., information that can enable electronic device 330 to establish a wireless connection, subscription information data, e.g., information that keeps track of podcasts or television shows or other media a user subscribes to, contact information data, e.g., telephone numbers and email addresses, calendar information data, and any other suitable data or any combination thereof.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 330. Although I/O circuitry 530 is illustrated in FIG. 4 as a single component of electronic device 330, several instances of I/O circuitry 530 can be included in electronic device 330.

Electronic device 330 can include any suitable interface or component for allowing a user to provide inputs to I/O circuitry 530. For example, electronic device 330 can include any suitable input mechanism, such as a button, keypad, dial, a click wheel, or a touch screen, e.g., display 550. In some embodiments, electronic device 330 can include a capacitive sensing mechanism, or a multi-touch capacitive sensing mechanism.

In some embodiments, electronic device 330 can include specialized output circuitry associated with output devices such as, for example, one or more audio outputs. The audio output can include one or more speakers, e.g., mono or stereo speakers, built into electronic device 330, or an audio component that is remotely coupled to electronic device 330, e.g., a headset, headphones or ear buds that can be coupled to device 330 with a wire or wirelessly.

Display 550 includes the display and display circuitry for providing a display visible to the user. For example, the display circuitry can include a screen, e.g., an LCD screen that is incorporated in electronics device 330. In some embodiments, the display circuitry can include a coder/decoder (Codec) to convert digital media data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 330, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 330 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 330 can include one more instances of communications circuitry 540 for simultaneously performing several communications operations using different communications networks, although only one is shown in FIG. 4 to avoid overcomplicating the drawing. For example, electronic device 330 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 330 can be coupled to a host device such as digital content control server 350 for data transfers, synching the communications device, software or firmware updates, providing performance information to a remote source, e.g., providing riding characteristics to a remote server, or performing any other suitable operation that can require electronic device 330 to be coupled to a host device. Several electronic devices 330 can be coupled to a single host device using the host device as a server. Alternatively or additionally, electronic device 330 can be coupled to several host devices, e.g., for each of the plurality of the host devices to serve as a backup for data stored in electronic device 330.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for organizing and presenting periodical digital publications on an electronic device comprising:
accessing a library that contains identifiers related to content available for use on the electronic device;
searching the identifiers and identifying periodical digital publications;
sorting the identified periodical digital publications by title;
displaying first icons representing at least a subset of the sorted titles, each icon representing a different title;
receiving an indication that the icon representing a specific title has been selected;
sorting the selected specific title by issues; and
displaying second icons representing at least a subset of the sorted issues.

2. The method according to claim 1, wherein the act of sorting the selected specific title by issues further comprises sorting the issues by date.

3. The method according to claim 1, further comprising sorting the identified periodical digital publications by a type of periodical digital publication.

4. The method according to claim 2, wherein the type of periodical digital publication includes newspapers and magazines.

5. The method according to claim 1, wherein the act of displaying the first icons representing at least the subset of the sorted titles further comprises displaying the first icons as representations of stacks of issues of the subset of the sorted titles.

6. The method according to claim 5, wherein the act of displaying the first icons as representations of stacks of issues of the subset of the sorted titles further comprises, with respect to a specific stack, displaying a thumbnail image of an issue of the title as a top issue on the specific stack.

7. The method according to claim 1, wherein the second icons representing at least the subset of the sorted issues are thumbnail images.

8. The method according to claim 1, wherein if a specific issue is not contained in a memory of the electronic device, the method further comprising displaying a download control element in connection with the second icon representing the specific issue.

9. The method according to claim 8, further comprising:
receiving an indication that the download control element has been selected;
contacting a remote server;
requesting a copy of the specific issue from the remote server;
receiving the copy of the specific issue; and
displaying the specific issue on the electronic device.

10. The method according to claim 1, further comprising
receiving an indication that a second icon representing a specific issue has been selected; and
displaying the specific issue on the electronic device.

11. A system for organizing and presenting periodical digital publications on an electronic device comprising:
a memory that includes instructions for operating the electronic device and includes a library that contains identifiers related to content available for use on the electronic device;
a display; and
control circuitry coupled to the memory and coupled to the display, the control circuitry executing the instructions and is operable to:
search the identifiers in the library and identify periodical digital publications;
sort the identified periodical digital publications by title;
display first icons on the display, the first icons representing at least a subset of the sorted titles, each first icon representing a different title;
receive an indication that the first icon representing a specific title has been selected;
sort the selected specific title by issues; and
display second icons representing at least a subset of the sorted issues.

12. The system according to claim 11, wherein the control circuitry is further operable to sort the issues by date.

13. The system according to claim 11, wherein the control circuitry is further operable to sort the identified periodical digital publications by a type of periodical digital publication.

14. The system according to claim 11, wherein the first icons are representations of stacks of issues of the subset of the sorted titles.

15. The system according to claim 14, wherein the control circuitry is further operable to display a thumbnail image of an issue of the title as a top issue on a specific stack.

16. The system according to claim 11, wherein the second icons representing at least the subset of the sorted issues are thumbnail images.

17. A system for organizing and presenting periodical digital publications comprising:
a remote server, the remote server having a server memory, the server memory storing a plurality of the periodical digital publications; and
an electronic device, the electronic device comprising:
a device memory that includes instructions for operating the electronic device and includes a library that contains identifiers related to content available for use on the electronic device,
communication circuitry,
a display; and
control circuitry coupled to the device memory, coupled to the communication circuitry and coupled to the display, the control circuitry executing the instructions and is operable to:
search the identifiers in the library and identify periodical digital publications;
sort the identified periodical digital publications by title;
display first icons on the display, the first icons representing at least a subset of the sorted titles, each first icon representing a different title;
receive an indication that the first icon representing a specific title has been selected;
sort the selected specific title by issues;
display second icons on the display, the second icons representing at least a subset of the sorted issues display a download control element on the display in connection with the second icon representing the specific issue;
receive an indication that the download control element has been selected;
use the communication circuitry to contact the remote server, request a copy of the specific issue from the remote server, and receive the copy of the specific issue from the remote server from the plurality of the periodical digital publications stored thereon; and
display the specific issue on the electronic device.
